(19) United States
(12) Patent Application Publication
(10) Pub. No.: US 2016/0009306 A1
(43) Pub. Date: Jan. 14, 2016

(54) Electrician's Cart

(71) Applicant: Joaquin Alejandro Garcia, Bonita, CA (US)

(72) Inventor: Joaquin Alejandro Garcia, Bonita, CA (US)

(21) Appl. No.: 14/328,528

(22) Filed: Jul. 10, 2014

(51) Int. Cl. B62B 3/00

(52) U.S. Cl. CPC B62B 3/005

(57) ABSTRACT

The present invention provides an improved electrician's cart having a set of wheels capable of rolling over various terrain types, ranging from indoors to outdoors. Vertical support rails extended upwards from the base are formed with spool bar receivers that are sized to removably receive a spool bar and retain it in place during use. The spool bars may be removed and replaced with different wire spools, and may be configured to accommodate any size or number of wire spool, depending on the need of an electrician. The present invention also may accommodate tools and other accessories, such as an umbrella for use when working outside, to be incorporated into the cart of the present invention. The present invention further includes an electrician's cart having a single layer of wire spools, and an electrician's cart which can be stood upright on its side provide a vertical array of wire spools.

### RELATED APPLICATIONS

This application is a continuation-in-part of, and claims the benefit of priority to, U.S. Utility patent application Ser. No. 13/523,753, entitled “Improved Electrician's Cart,” filed on Jun. 14, 2012, and current co-pending, which claims the benefit of priority to U.S. Provisional Application Ser. No. 61/496,783, entitled “Improved Electrician's Cart,” filed on Jun. 14, 2011.

### FIELD OF THE INVENTION

The present invention relates generally to utility carts. The present invention is more particularly, though not exclusively, related to utility carts for electricians to provide a portable workstation capable of storing multiple wire spools and related equipment.

### BACKGROUND OF THE INVENTION

Utility carts are widespread in the construction industry. In fact, many carts are created for specific trades, such as a plumber's cart, and heating ventilation and an air conditioning (HVAC) cart, and the like, In order for the cart to be useful for a specific trade, it must take into consideration the various environments in which the cart will be used. For instance, when performing the initial electrical wiring for a building, a cart capable of rolling over rough terrain would be required. On the other hand, when performing the finish wiring inside an existing building, a cart capable of rolling through business or residential environments will be required,

Several carts have been created for use by electricians, However, those carts available do not provide the electricians with suitable options for the various types of work that the electrician may encounter during his or her work. For instance, a wiring cart that is designed for inside wiring services is not capable of use in outside environments. Similarly, a cart designed for transporting wires suitable for indoor circuits is not capable of use for larger sized wires that are used in service or solar installations.

In light of the above, it is advantageous to provide an electrician's wiring cart that accommodates virtually any project the electrician may be required to perform. It is also advantageous to provide a cart that may be used both inside on rough terrain and inside finished buildings. It is further advantageous to provide a cart that is adaptable for any wiring project, from large diameter wire spools used for electrical service and smaller diameter wire spools used for inside circuits. It is also advantageous to provide a cart that may be stood upright during use, enabling an electrician to save space or to prevent the cart from rolling, and a portable cart enabling an electrician to carry the cart through use of a pulling handle.

### SUMMARY OF THE INVENTION

An improved electrician's cart is provided and includes a base having a set of wheels capable of rolling over various terrain types, ranging from indoors to outdoors. Vertical support rails extend upwards from the base and are attached at the uppermost end with a tubular connecting bar that runs the perimeter of the cart. Each vertical support rail is formed with a number of spool bar receivers that are sized to receive a spool bar and retain it in place during use. The spool bars may be removed and replaced with different wire spools, and may be configured to accommodate any sized or number of wire spool. Accessories may also be incorporated into the cart of the present invention, and may include a number of accessory tubes mounted to the vertical rails, and can accommodate tools and other accessories, such as an umbrella, for use when working outside. A number of trays may also be configured for mounting through the spool bar receivers. In addition, to accommodate the various needs of an electrician, alternative embodiments of the present invention further includes an electrician's cart in a smaller scale comprising a single layer of wire spools, or a portable electrician's cart using a pulling handle, or an electrician's cart which can be positioned upright on the floor or ground to provide a direct pulling route from multiple wire spools, to save space during uses and storage, or to prevent the cart from rolling during use.

In an alternative embodiment of the present invention, the improved electrician's cart includes support rails attached to the base of the electrician's cart and oriented in a triangular shape. The support rails are reinforced with tubular connecting bars to further form a triangular prism frame. Further, in an alternative embodiment the triangular prism frame constructed of support rails and tubular connecting bars is constructed with a base without wheels.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a perspective view of the electrician's cart of the present invention showing the planar base with vertical support rails extending upwards from the base, the tubular connecting bars and removable spool bars that can be positioned in any number of spool bar receivers formed in the vertical rails;

FIG. 2 is a side view of the electrician's cart of the present invention showing the vertical rails, the spool bar receivers, and the base having a number of wheels for easy movement of the cart;

FIG. 3 is an enlarged view of detail 3-3 of the electrician's cart of the present invention of FIG. 2, showing the spool bar receiver and the positioning of a spool bar within the channel formed in the vertical rail and secured in place for use;

FIG. 4 is a front view of the electrician's cart of the present invention showing the placement of the spool bar within the spool bar receivers formed in the vertical rails extending from the base, and a separate exemplary spool bar showing the smaller diameter circumferential channel that engages the spool bar receiver to prevent the bar from moving during use;

FIG. 5 is an exemplary embodiment of the electrician's cart of the present invention showing multiple wire spools on a spool bar placed in the spool bar receiver for use, and an accessory umbrella providing protection for the wires and a cart, positioned in the accessory tubes;

FIG. 6 is a side view of an exemplary embodiment of the electrician's cart of the present invention showing a number of different sized wire spools positioned on spool bars with each positioned within a spool bar receiver, a pulling handle that attached to the base and provides for easy transportation of the cart, and a tray sized and configured to use the spool bar receivers for mounting to the cart;

FIG. 7 is a perspective view of an alternative embodiment of the electrician's cart of the present invention showing multiple wire spools positioned on a single layer of spool bars with each placed within a spool bar receiver on the connecting bar, and the base having a number of wheels for easy movement of the cart;

FIG. 8 is a perspective view of an alternative embodiment of the electrician's cart of the present invention showing multiple spool bars placed within spool bar receivers on the vertical support rails, wherein multiple wire spools may selectively be positioned, the base having a number of wheels for easy movement of the cart, and sidewalls enabling the cart to be stood upright during use;

FIG. 9 is a perspective view of an alternative embodiment of the electrician's cart of the present invention showing the cart which is stood upright on the floor using the sidewall on the cart, to provide a vertical array of wire spools, and to save space in confined areas and to prevent the cart from roiling during use;

FIG. 10 is a perspective view of an alternative embodiment of the electrician's cart of the present invention showing multiple spool bars placed within spool bar receivers on the vertical support rails, wherein multiple wire spools may selectively be positioned, the base having a number of wheels for easy movement of the cart, a supporting structure having columns and connecting bars, and a pulling handle placed underneath the cart while not in use;

FIG. 11 is a perspective view of an alternative embodiment of the electrician's cart of the present invention showing the cart which can be easily carried using the pulling handle and stood upright on the floor using the supporting structure on the cart, to provide a vertical array of wire spools, and to save space in confined areas and to prevent the cart from rolling during use;

FIG. 12 is a perspective view of an alternative embodiment of the electrician's cart of the present invention showing the planar base with support rails formed with a number of spool bar receivers extending upwards from the base at an angle to form a triangular shape with vertical and tubular connecting bars attached to the support rails and removable spool bars that can be positioned in any number of spool bar receivers;

FIG. 13 is a side view of the electrician's cart of FIG. 12 showing the support rails, the spool bar receivers, and the base having a number of wheels for easy movement of the cart;

FIG. 14 is a perspective view of an alternative embodiment of an electrician's cart of the present invention with supports rails and tubular connecting bars oriented in the shape of a triangular prism having the base of an isosceles triangle; and

FIG. 15 is a perspective view of an alternative embodiment of an electrician's cart of the present invention with supports rails and tubular connecting bars oriented in the shape of a triangular prism having the base of a right triangle.

### DETAILED DESCRIPTION OF THE INVENTION

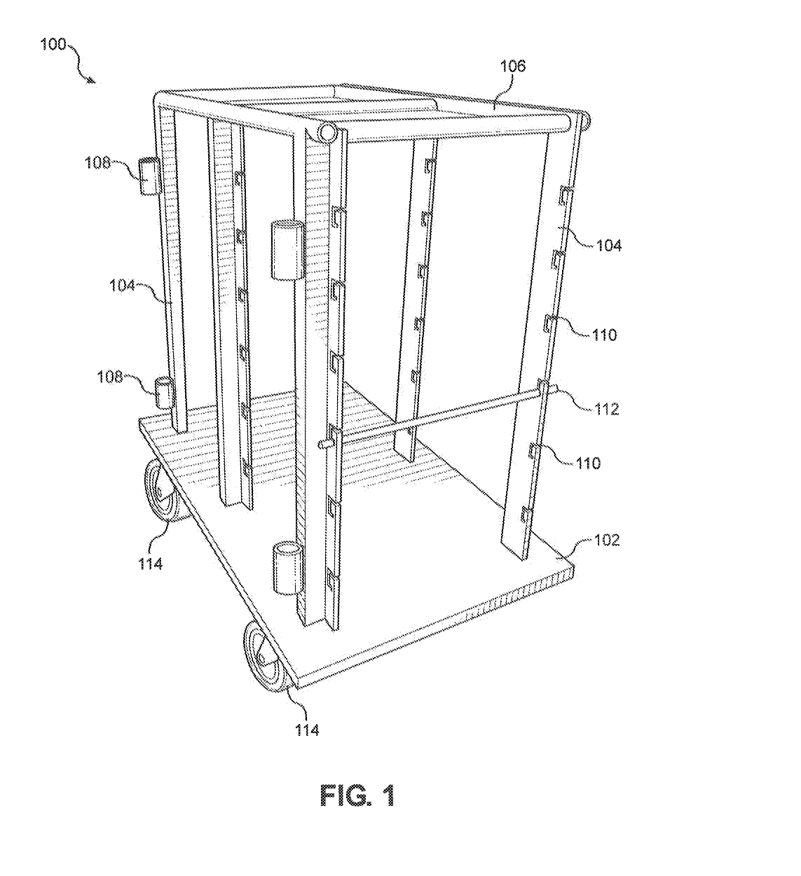

Referring initially to FIG. 1, a perspective view of the electrician's cart of the present invention is shown and generally designated 100. Cart 100 includes a planar base 102. Extending upwards from the base 102 are six (6) vertical support rails 104. The upper end of each vertical support rail is attached to a tubular connecting bar 106 which forms a rigid frame having considerable strength.

In a preferred embodiment, base 102, vertical support rails 104 and tubular connecting bars 106 are formed from high strength aluminum which provides significant strength yet is lightweight and easy to maneuver. Alternative embodiments may be manufactured using other materials known in the art, including but not limited to steel, high density plastic or resin, and fiber reinforced plastic composites such as fiberglass and carbon fiber.

Each vertical support rail 104 is formed with a number of spool bar receivers 110. The specific detail of the spool bar receiver 110 will be discussed below in conjunction with FIG. 3. A removable spool bar 112 can be positioned in any number of spool bar receivers 110 formed in the vertical rails 104. This versatility provides an electrician to customize the cart of the present invention for each specific project.

A number of accessory tubes 108 may be mounted to the vertical support rails 104, and the base 102 is equipped with a number of wheels 114 as is known in the art.

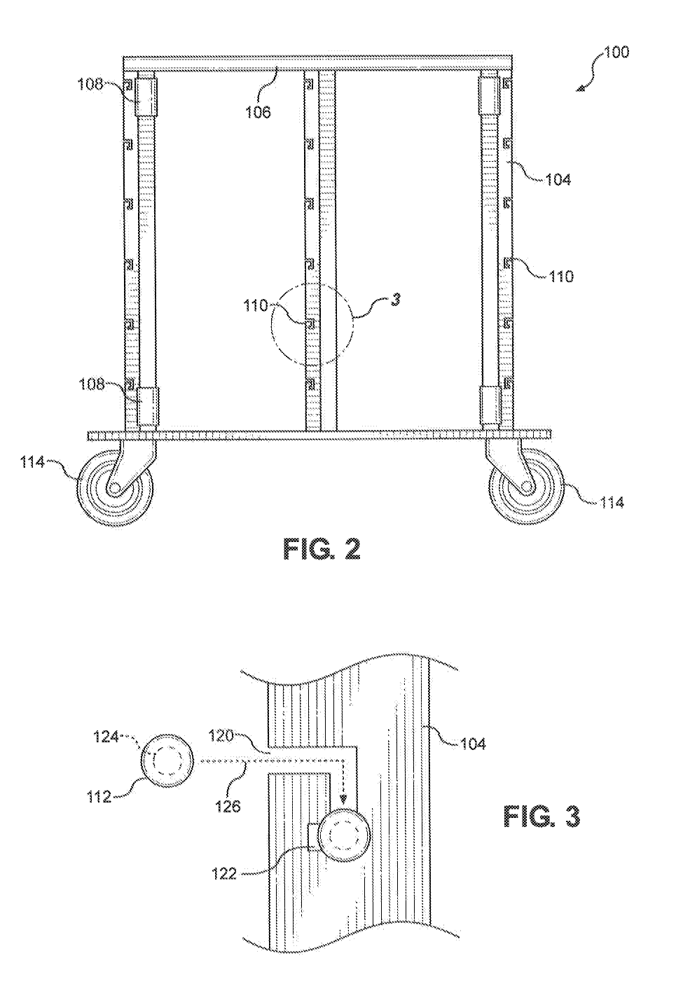

FIG. 2 is a side view of the electrician's cart 100 of the present invention shown in FIG. 1, detailing the vertical rails 104 and the positioning of the spool bar receivers 110. Specifically, as shown in this embodiment, the spool bar receivers 110 are spaced vertically equidistant from each other, and initially spaced to accommodate a 500′ spool of 12 gauge wire on each spool bar 112. In instances when larger spools must be accommodated, spool bars 112 may be separated.

Referring to FIG. 3, an enlarged view of detail 3-3 of the electrician's cart 100 of the present invention of FIG. 2 is shown. From this view, the shape of the spool bar receiver 110 is clear. Specifically, a spool bar 112 is formed with a channel 120 that is sized to receive the circumferential groove 124 of the spool bar 112 to prevent side-to-side movement of the spool bar 112. The circumferential groove 124 is aligned with the spool bar receiver 110 and the spool bar 112 is advanced in direction 126 into a channel 120. Once at the lower end 122 of the spool bar receiver 110, the spool bar 112 is secured within the vertical rail 104 and secured in place for use. When necessary, the spool bar 112 may be removed simply by lifting the spool bar 112 and sliding it in reverse direction 126.

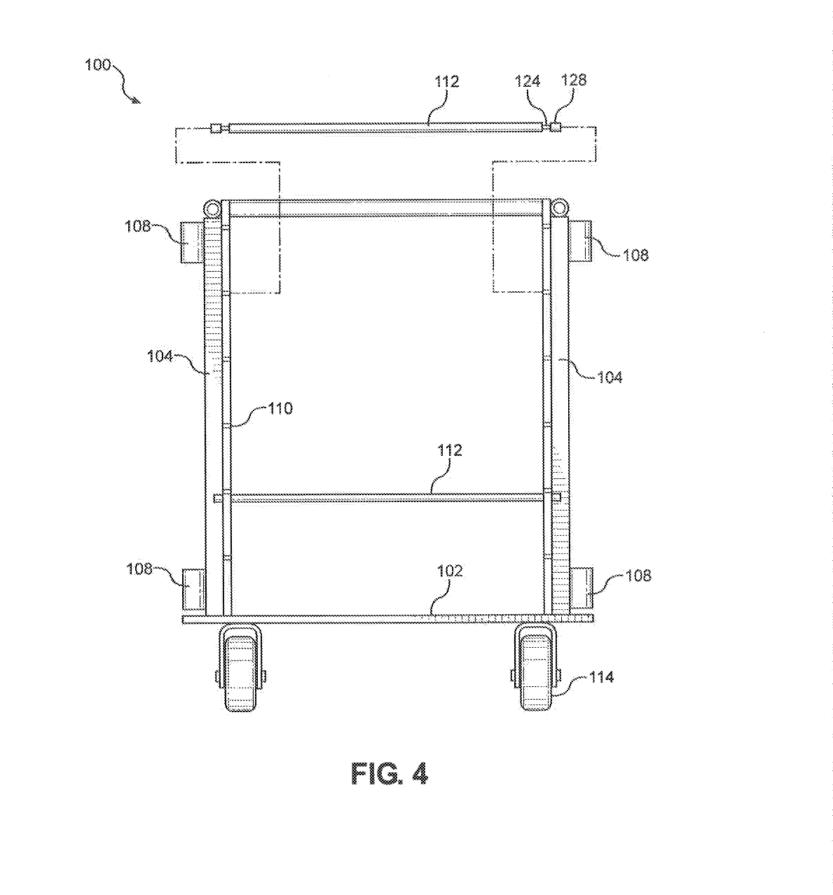

FIG. 4 is a front view of the electrician's cart 100 of the present invention and shows the placement of the spool bar 112 within the spool bar receivers 110 formed in the vertical rails 104 extending from the base 102. An exemplary spool bar 112 is shown and includes a circumferential groove 124 having a diameter smaller than the spool bar receiver channel 120, and having an end 128 sized to prevent the spool bar 112 from side-to-side movement during use. A separate exemplary spool bar 112 is shown as installed in the spool bar receivers 110 of vertical support rails 104.

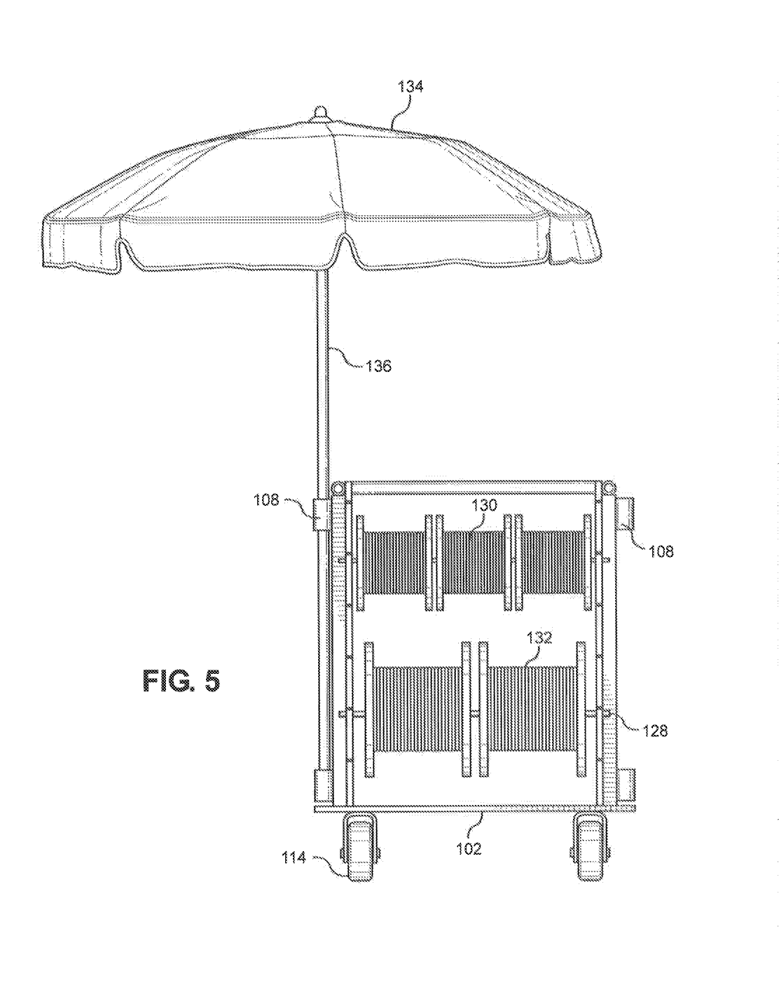

FIG. 5 is an end view of an exemplary embodiment of the electrician's cart 100 of the present invention. In this configuration, multiple wire spools 130 and 132 are positioned on a spool bar 112 and placed in the spool bar receiver 110 for use. As shown, only two (2) of the six (6) available spool bar receivers 110 are being used in this configuration since the wire spools 130 and 132 are large,

An accessory umbrella 134 is positioned such that an umbrella pole 136 is within the accessory tube 108 and provides protection for the wires and a cart. Accessory tubes 108 may also be used for elongated tools, such as a tool used to bend electrical metallic tubing (EMT).

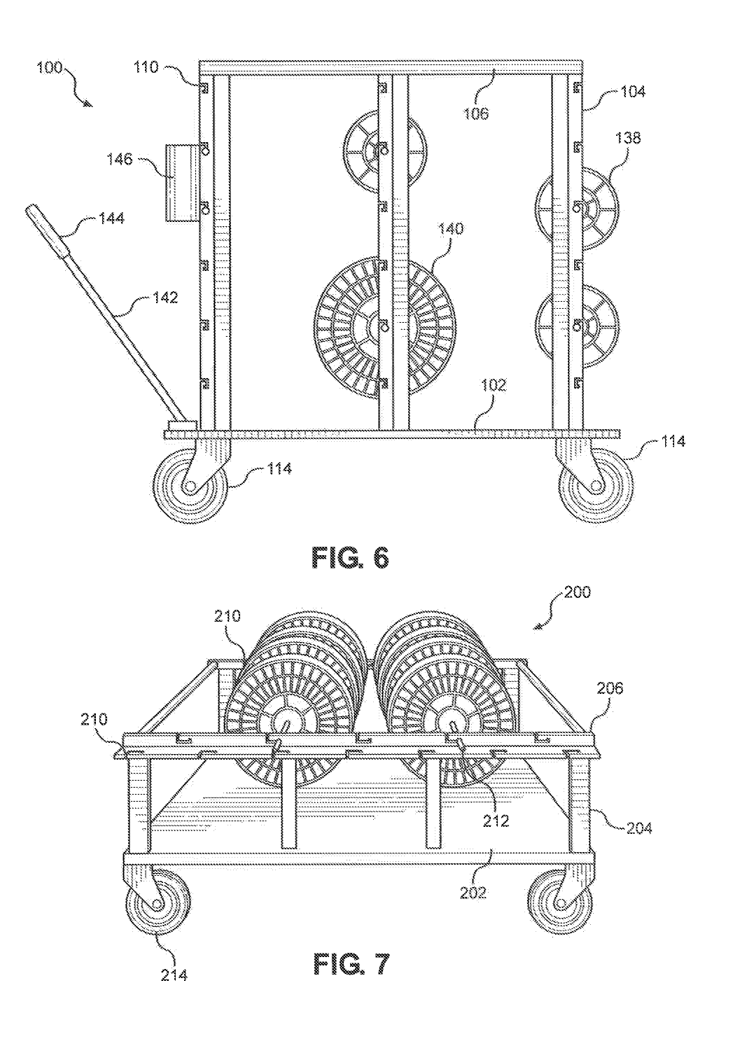

Referring now to FIG. 6, a side view of an exemplary embodiment of the electrician's cart 100 of the present invention is shown and includes a number of different sized wire spools 138 and 140 positioned on the spool bars 112 with each positioned within a spool bar receiver 110. By selectively populating the spool bars with appropriate wire spools, and positioning the spools on the cart 100, virtually any number or combination of wire spools and wire types may be accommodated.

Cart 100 is also equipped with a pulling handle 142 attached to the base 102 and provides for easy transportation of the cart. The wheels 114 on the cart may be fixed, or they may rotate as is known in the art to provide steering. By fixing the wheels 114 on the opposite end of the base 102 than the pulling handle 142, the cart 100 can be easily steered during use. Also, to provide an easier pulling surface for the user, a larger handle 144 may be provided.

Cart 100 is also equipped with a tray 146 sized and configured to use the spool bar receivers 110 for mounting to the cart 100. As shown, a tray 146 includes two posts spaced apart vertically for positioning into vertically adjacent spool bar receivers 110. It is to be appreciated that larger trays 146 may be accommodated by using spool bar receivers 110 that are not adjacent, thereby providing for a larger tray or other device, such as a tool box.

Referring to FIG. 7, a perspective view of an alternative embodiment of the electrician's cart of the present invention is shown and generally designated 200. Cart 200 includes a planar base 202. Extending upwards from the base 202 are eight (8) short vertical support rails 204. The upper end of each vertical support rail is attached to a horizontal support rail 206 which forms a rigid frame having considerable strength. The rigid frame is constructed with high strength aluminum which provides significant strength yet is lightweight, however it is not meant to be limiting. It is contemplated that Cart 200 may be manufactured using other materials known in the art, including but not limited to steel, high density plastic or resin, and fiber reinforced plastic composites such as fiberglass and carbon fiber.

Differently from the preferred embodiment where each vertical support rail is formed with a number of spool bar receivers, in an alternative embodiment 200, instead of the vertical support rails, each horizontal support rail 206 is formed with a number of spool bar receivers 210. A removable spool bar 212 can be positioned in any number of spool bar receivers 210 formed in the horizontal support rail 206. This alternative embodiment 200 provides an electrician one (1) layer of spool bars positioned within the spool bar receivers 210 to customize the cart of the present invention depending on the need of the electrician. Alternative embodiment 200 may be more useful for more instant use of the cart with a few spools, relatively in smaller sizes, by an electrician working on a relatively small project. The base 202 is equipped with a number of wheels 214 as is known in the art, for easy movement of the cart during use.

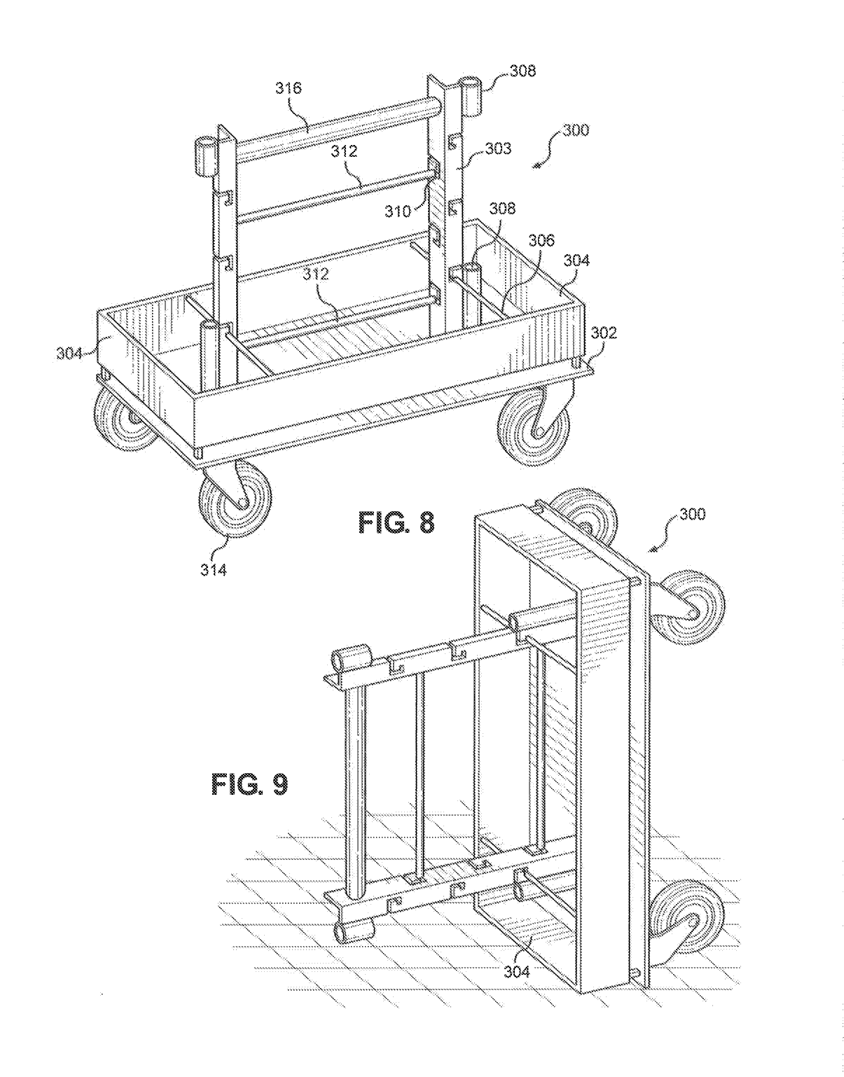

FIG. 8 depicts another alternative embodiment illustrating the versatility provided by the present invention to customize the cart for an electrician. In FIG. 8, a perspective view of an alternative embodiment of the electrician's cart of the present invention is shown and generally designated 300. Cart 300 includes a planar base 302. Extending upwards from the base 302 are side walls 304 wherein the end of each supporting member 306 is welded to support two vertical support rails 303. The upper end of each vertical support rail 303 is attached to a tubular connecting bar 316 which forms a rigid frame having considerable strength. The rigid frame is constructed with high strength aluminum which provides significant strength yet is lightweight, however it is not meant to be limiting. It is contemplated that Cart 300 may be manufactured using other materials known in the art, including but not limited to steel, high density plastic or resin, and fiber reinforced plastic composites such as fiberglass and carbon fiber. Each vertical support rail 303 is formed with a number of spool bar receivers 310. A removable spool bar 312 can be positioned in any number of spool bar receivers 310 formed in the vertical rails 303.

A number of accessory tubes 308 may also be mounted on the base 302, and attached to the vertical support rail 303. Accessory tubes 308 may be used for umbrella or elongated tools, such as a tool used to bend electrical metallic tubing (EMT). The base 302 is equipped with a number of wheels 314 as is known in the art, for easy movement of the cart during use.

FIG. 9 illustrates a perspective view of the electrician's cart 300 of the present invention when it is stood upright on the floor using the side wall 304, An electrician can selectively stand the cart upright when an electrician needs to save space for the electrician's cart 300 or to prevent the cart 300 from rolling, during his or her use.

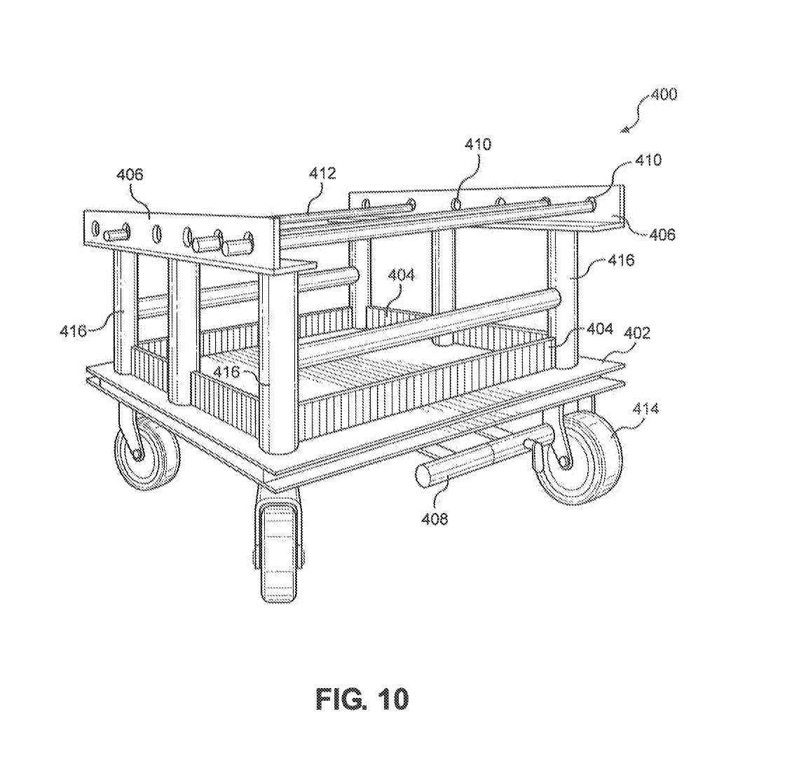

FIG. 10 depicts another alternative embodiment illustrating the versatility provided by the present invention to customize the cart for an electrician. In FIG. 10, a perspective view of an alternative embodiment of the electrician's cart of the present invention is shown and generally designated 400. Cart 400 includes a planar base 402. Extending upwards from the base 402 are side walls 404 wherein the supporting structure 416 having columns and connecting bars is welded to support two horizontal support rails 406. The upper end of each column on the supporting structure 416 is attached to the bottom end of the horizontal support rails 406, forming a rigid frame having considerable strength. The rigid frame is constructed with high strength aluminum which provides significant strength yet is lightweight, however it is not meant to be limiting. It is contemplated that Cart 400 may be manufactured using other materials known in the art, including but not limited to steel, high density plastic or resin, and fiber reinforced plastic composites such as fiberglass and carbon fiber. Each horizontal support rail 406 is formed with a number of spool bar receivers 410. A removable spool bar 412 can be positioned in any number of spool bar receivers 410 formed in the horizontal support rails 406,

A pulling handle 408 is attached to the base 402 and provides for easy transportation of the cart. The pulling handle 408 is placed underneath the base 402 when it is not in use and pulled out when easy transportation of the cart is necessary. In addition, the base 402 is equipped with a number of wheels 414 as is known in the art, for easy movement of the cart during use. The wheels 414 on the cart 400 may be fixed, or they may rotate as is known in the art to provide steering.

The alternative embodiment 400 provides for a smaller embodiment than the preferred embodiment. The alternative embodiment 400 of the present invention will be manufactured as 20″ in width, 20″ in height, and 30″ in depth, forming a smaller electrician's cart of the present invention, for its portable use on relatively small projects. However, by adopting a number of removable spool bars 412 which can be positioned in any number of spool bar receivers 410, this alternative embodiment 400 of the present invention can accommodate up to twelve (12) spool bars of 12″ wire,

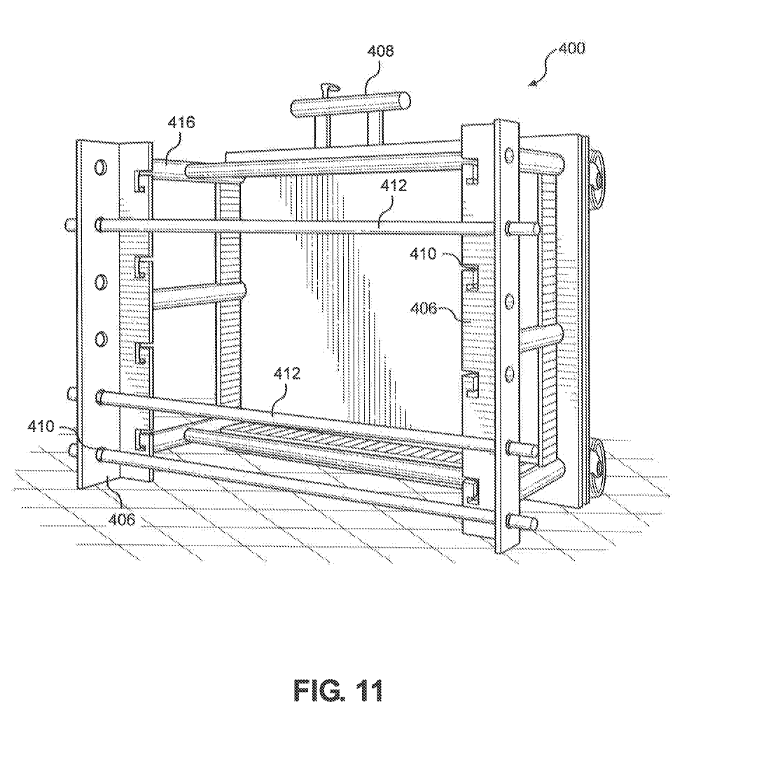

FIG. 11 illustrates a perspective view of the electrician's cart 400 of the present invention when it is stood upright on the floor using the supporting structure 416 having columns and connecting bars and horizontal support rails 406. An electrician can selectively stand the cart upright when an electrician needs to save space for the electrician's cart 400 or to prevent the cart 400 from rolling, during his or her use. In addition, using a puffing handle 408 located underneath the electrician's cart 400, an electrician can portably carry the cart 400 without rolling the wheels 414 to transport the cart 400, and stand the cart 400 upright on the floor.

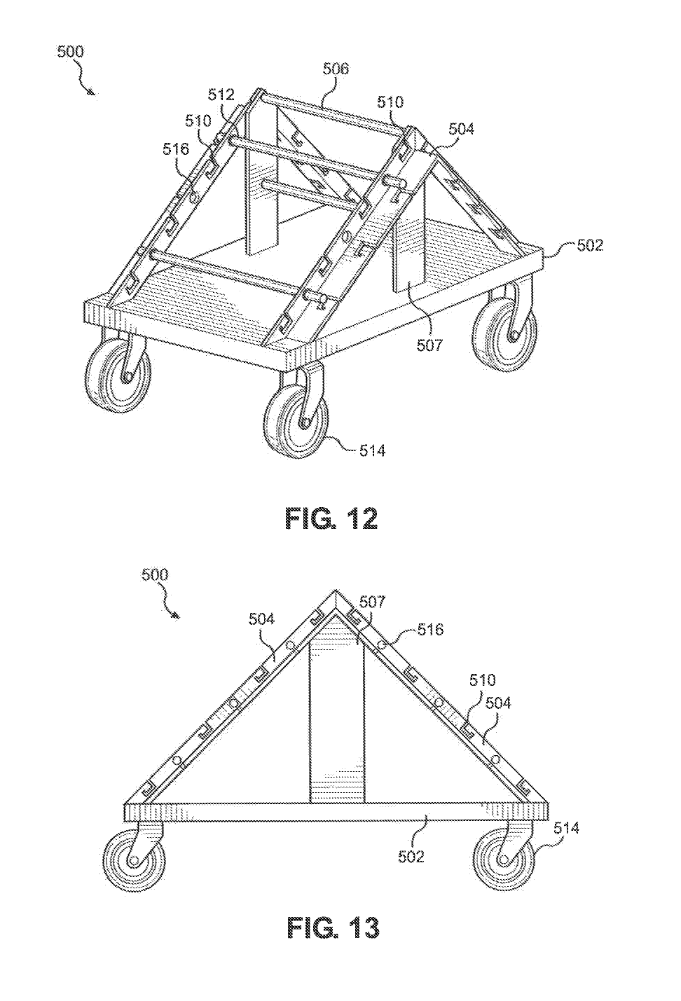

Referring now to FIG. 12, a perspective view of an alternative embodiment of the electrician's cart of the present invention is shown and generally designated 500. Cart 500 includes a planar base 502 equipped with a number of wheels 514 as is known in the art Extending at an angle upwards from the base 502 are four (4) support rails 504, with each pair of support rails 504 forming a triangular base. A tubular connecting bar 506 attached to the apex of each triangular base, forming a triangular prism frame having considerable strength and rigidity. Vertical members 507 extending from the base 502 further attaches to the apex of each triangle to provide further structural strength and rigidity. Cart 500 is formed from high strength aluminum which provides significant strength yet is lightweight and easy to maneuver. The use of aluminum is not meant to be limiting and it is contemplated that Cart 500 may be manufactured using other materials known in the art, including but not limited to steel, high density plastic or resin, and fiber reinforced plastic composites such as fiberglass and carbon fiber.

Each support rail 504 is formed with a number of slotted spool bar receivers 510 and circular spool bar receivers 516. The slotted spool bar receiver 510 is substantially similar to spool bar receiver 110 discussed above and shown in FIG. 3, the details and description of which are fully incorporated herein. The circular spool bar receiver 516 is a circular hole formed into the support rails. A removable spool bar 512, substantially similar to spool bar 112, can be positioned in any number of slotted spool bar receivers 510 or circular spool bar receivers 516 formed in the support rails 504. A number of accessory tubes, trays, or handles may be mounted to the cart 500 as well. This versatility provides an electrician the ability to customize the cart of the present invention for each specific project.

The cart 500 can accommodate numerous spool sizes due to its shape. The bottom of the triangular prism frame is wider to accommodate larger sized spools and the top is narrower to accommodate smaller sized spools. Further, there are no subsequent rails before or after the support rail 504 to inhibit the size of the spools used. This gives the electrician a greater degree of customization when choosing which spools to use.

FIG. 13 is a side view of cart 500 showing a face of the triangular prism frame made of support rails 504, tubular connecting bars 506 and vertical members 507. As shown, one of the triangular bases of the triangular prism frame includes two support rails 504 extending upwards from the base 502 at an angle and attaching to one another. Vertical member 507 attaches between the apex of the triangle formed by the support rails 504 and the base 502 to provide additional strength and rigidity to the triangular prism frame. The support rails 504 are substantially equal in length, however the lengths of the support rails 504 are not meant to be limiting. Various lengths and resulting triangle shaped configurations are contemplated without departing from the scope and spirit of the invention.

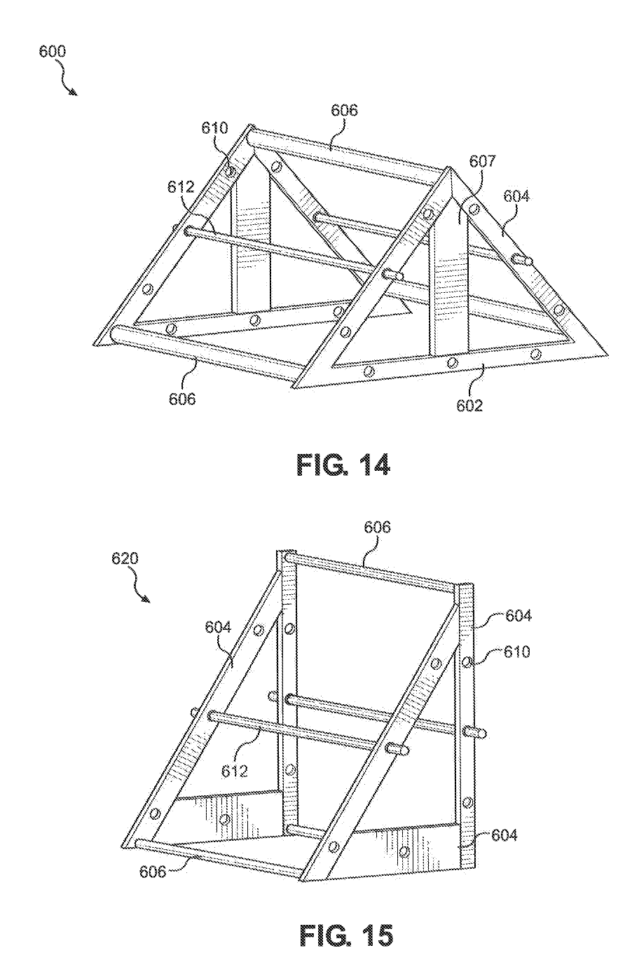

Referring now to FIG. 14, an alternative embodiment of the electrician's cart of the present invention is shown and generally designated 600, The cart 600 includes a triangular prism frame comprising support rails 604, tubular connecting bars 606, and vertical support members 607. The support rails 604 are oriented to form an isosceles triangle base and tubular connecting bars 606 connect the bases together at each point of each triangle, forming the triangular prism frame. On each base, a vertical support member 607 is attached to provide additional rigidity and strength to the frame. The support rails 604 are substantially equal in length, however the lengths of the support rails 604 are not meant to be limiting. Various sizes, lengths, and triangle shaped configurations are contemplated, as shown in FIG. 15, without departing from the scope and spirit of the invention. The Cart 600 is constructed with high strength aluminum which provides significant strength yet is lightweight, however it is not meant to be limiting. It is contemplated that Cart 200 may be manufactured using other materials known in the art, including but not limited to steel, high density plastic or resin, and fiber reinforced plastic composites such as fiberglass and carbon fiber.

Formed into the support rails 604 are spool bar receivers 610. A removable spool bar 612 can be positioned in any number of spool bar receivers 610 formed in the support rails 604. As shown, the spool bar receiver 610 is a circular hole formed into the support rail 604. It is contemplated that the spool bar receiver 610 may be slotted substantially similar to spool bar receiver 110 discussed above and shown in FIG. 3. The cart 600 can accommodate numerous spool sizes due to its triangular shape. As a triangular prism, the bottom of the cart 600 is wider to accommodate larger sized spools and the top is narrower to accommodate smaller sized spools. This gives the electrician a greater degree of customization when choosing which spools to use, Further, there are no wheels attached allowing the placement of the cart 600 at a location without worry of the cart 600 rolling away. Referring now to FIG. 15, a variation of the electrician's cart 600 is shown and generally designated 620. The electrician's cart 620 is substantially similar to electrician's cart 600 and wherein like reference numerals designate like elements. The cart 620 includes a triangular prism frame comprising support rails 604, tubular connecting bars 606, and vertical support members 607. The support rails 604 are oriented to form a right-triangle and tubular connecting bars 606 connect the triangular bases together at each point of each triangle, forming the triangular prism frame. Instead of using additional support members to provide additional strength and rigidity to the frame, the electrician's cart 620 utilizes several different sized support rails 604.

Formed into the support rails 604 are spool bar receivers 610. A removable spool bar 612 can be positioned in any number of spool bar receivers 610 formed in the support rails 604. The cart 620 can accommodate numerous spool sizes due to its triangular shape. Further, the frame may be repositioned for the user to utilize different support rails. By placing the cart 620 on different sides, different support rails become available for use, This gives the electrician a greater degree of customization when choosing which spools to use.

While there have been shown what are presently considered to be preferred embodiments of the present invention, it will be apparent to those skilled in the art that various changes and modifications can be made herein without departing from the scope and spirit of the invention.

1. An electrician's cart, comprising:
a planar base;
a plurality of support rails extending upwards at an angle from said planar base and forming a first triangular base and a second triangular base, each said support rail formed with at least one spool bar receiver;
at least one removable spool bar extending from said spool bar receiver in one said support rail to said spool bar receiver in another said support rail; and
a plurality of wheels extending from said planar base opposite said support rails.

2. The electrician's cart of claim 1 further comprising at least one tubular connecting bar extending between said first triangular base and said second triangular base, forming a rigid triangular prism frame.

3. The electrician's cart of claim 1 wherein said connecting bars are formed with a number of spool bar receivers.

4. The electrician's cart of claim 1 further comprising a plurality of vertical support members, wherein each of said vertical support members attaches to each of said triangular bases and said planar base.

5. The electrician's cart of claim 3, wherein said spool bar receiver comprises a channel having a channel width.

6. The electrician's cart of claim 5 wherein said removable spool bar has two ends, and is formed with a circumferential groove adjacent each end and having a diameter smaller than said channel width of said spool bar receiver, and an end sized to prevent said spool bars from side-to-side movement during use.

7. The electrician's cart of claim 3, wherein said spool bar receiver comprises a hole having a diameter.

8. The electrician's cart of claim 7 wherein said spool bar has two ends, and is formed with a circumferential groove adjacent each end, said ends sized smaller than said hole diameter of said spool bar receiver and said circumferential grooves having a diameter smaller than said ends, wherein said circumferential groove prevents said spool bar from side-to-side movement during use.

9. The electrician's cart of claim 4 further comprising at least one accessory tube attached to and substantially parallel to one said vertical support member.

10. The electrician's cart of claim 9 wherein said accessory tubes are sized to receive a tool therethrough.

11. The electrician's cart of claim 3 further comprising a tray sized and configured for mounting to said spool bar receivers.

12. The electrician's cart of claim 3 wherein one or more spool bars are selectively positioned within said spool bar receivers.

13. The electrician's cart of claim 1 wherein at least one of said wheels are fixed to rotate in a plane.

14. The electrician's cart of claim 1 wherein each said wheel may rotate for easy steering during use.

15. An electrician's cart comprising:
a plurality of support rails arranged at an angle to form a first triangular base and a second triangular base, each said support rail formed with at least one spool bar receiver;
a planer base;
a plurality of tubular connecting bars extending between said first triangular base and said second triangular base, forming a triangular prism frame; and
at least one removable spool bar extending from said spool bar receiver in one said support rail to said spool bar receiver in another said support rail.

16. The electrician's cart of claim 15, wherein said electrician's cart further comprises a plurality of vertical support members, wherein each of said vertical support members extends between each of said support rails.

17. The electrician's cart of claim 15, wherein said spool bar receiver comprises a channel having a channel width.

18. The electrician's cart of claim 15 wherein said removable spool bar has two ends, and is formed with a circumferential groove adjacent each end and having a diameter smaller than said channel width of said spool bar receiver, and an end sized to prevent said spool bars from side-to-side movement during use.

19. The electrician's cart of claim 15, wherein said spool bar receiver comprises a hole having a diameter.

20. The electrician's cart of claim 15, wherein said spool bar has two ends, and is formed with a circumferential groove adjacent each end, said ends sized smaller than said hole diameter of said spool bar receiver and said circumferential grooves having a diameter smaller than said ends, wherein said circumferential groove prevents said spool bar from side-to-side movement during use.
